(19) United States
(12) Patent Application Publication
(10) Pub. No.: US 2015/0105101 A1
(43) Pub. Date: Apr. 16, 2015

(54) Method And System For Spatio-Temporal Adjustment Of Geolocation Permissions

(71) Applicant: Stéphane Schmoll, Meudon (FR)

(72) Inventor: Stéphane Schmoll, Meudon (FR)

(73) Assignee: Deveryware, Paris (FR)

(21) Appl. No.: 14/401,610

(22) PCT Filed: May 24, 2013
(86) PCT No.: PCT/FR2013/051143

§ 371 Date: Nov. 17, 2014

(30) Foreign Application Priority Data
May 25, 2012 (FR) 1254821

(51) Int. Cl. H04W 4/02

(52) U.S. Cl. CPC H04W 4/02
USPC 455/456.1

(57) ABSTRACT

A method to manage the location of a user of at least one apparatus that includes a device for geolocation of the latter being able to transmit geolocation data to a plurality of receivers. the method includes parameterization of a filter for defining at least one spatio-temporal criterion of accessibility of the geolocation data by at least one of the receivers, the parameterization being done by a user interface allowing the user to parameterize by himself a database associating the receivers and the associated spatio-temporal criteria; activation, or deactivation, by the filter of the transmission of the geolocation data to each receiver as a function of the spatio-temporal criterion (or criteria) associated therewith. The user having a plurality of apparatuses the parameterization is carried out for several apparatuses.

### BACKGROUND

The present invention relates to the management of permissions of being located in real-time by third parties, whatever are the technologies or the modes used for the geolocation.

### SUMMARY

The permission of being located has long been a binary concept (I would like or I do not wish) independent of the application that is likely to locate, and all the more independent of any context. Yet, the regulation applicable to this type of data, personal data type, is tending toward a better control by the user of its geolocation data.

There is a real need to be able to manage in real-time the permissions of being located by third parties, regardless of the location technologies that are used, with the aim to control the broadcast and protect one's personal geolocation data, whether on the private and personal level, on the professional level, on the level of contextual (geolocated) advertisements or even related to civil security in general. No system precedingly developed makes it possible to meet this growing need. Indeed, with the very strong development of smart mobile phones (“smartphones” in English), the geolocation becomes omnipresent and develops a sense of insecurity among the majority of users.

For example, with the emergence of smart mobile phones and the applications loaded thereon, each application asks henceforth whether the user of the mobile agrees to be located in order to benefit from the service rendered. For the applications locating third parties, the consent applies for a specific person.

Major drawbacks remain:

the user cannot specify when he agrees to be located nor where;

he cannot globally manage his permissions: if he wishes to modify them, he has do it in each application, which may be tedious and cause prejudicial errors;

in most cases, the permissions may be specified only on the mobile where the application is located, without the possibility of modifying them from other fixed or mobile terminals.

The invention aims to remedy all or part of the drawbacks of the state of the art identified above.

One aspect of the invention relates to a method for managing the location of a user of at least one apparatus, the apparatus including a geolocation device thereof being able to transmit geolocation data to a plurality of receivers, comprising:

the parameterization of a filter for defining at least one spatio-temporal criterion of geolocation data accessibility by at least one of the receivers, the parameterization being done by a user interface allowing the user to parameterize by himself a database associating the receivers and the associated spatio-temporal criteria;

the activation, or the deactivation, by the filter of the transmission of the geolocation data to each receiver depending on the spatio-temporal criterion(criteria) associated thereto.

Furthermore, the user having a plurality of apparatuses, the parameterization is performed for several apparatuses.

Thus, advantageously, the method allows:

specifying time ranges (days, hours) during which the location is agreed by the mobile internet user;

specifying the validity duration of the location permission;

specifying areas or places where the location is allowed;

limiting the precision of the location, for example the user can agree to be located as being in a town but without wishing that his exact position, for example the street and the number where he is, be accessible;

globally managing the permissions from one single interface summarizing the services or the third parties authorized to locate the mobile internet user, and this regardless of the apparatus used; and/or

accessing the interface from any fixed or mobile terminal and with various human-machine interfaces, including verbal dialog.

Characteristics or particular embodiments, usable alone or in combination, are:

the spatio-temporal criteria comprise time ranges and/or geographical areas;

when the filter activates the transmission of geolocation data, these are provided with a precision defined by the user;

the parameterization of the filter is synchronized between all the apparatuses;

when the filter is parameterized for a new receiver, a validation step of the receiver is performed;

the receiver comprising a specific application, the filter interfaces with the application to provide, or not, the geolocation data;

the filter generates an alarm toward the user when an application attempts to retrieve the geolocation data in spite of the deactivation; and/or

the filter records every location request for providing the user with the history of the location requests.

A second aspect of the invention concerns a computer program product comprising program code instructions for the execution of the steps of the method according to any of the precedingly described embodiments when the program is executed on a computer.

A third aspect of the invention concerns a system for managing the location of a user of an apparatus, the apparatus including a geolocation device thereof being able to transmit geolocation data to a plurality of receivers, the system comprising a parameterizable filter adapted to define at least one spatio-temporal criterion of geolocation data accessibility by at least one of the receivers and to activate, or deactivate, the transmission of the geolocation data to the receiver depending on the spatio-temporal criterion, and a user interface for parameterizing the filter allowing the user to parameterize by himself a database associating the receivers and the spatio-temporal criteria, characterized in that, the user having a plurality of apparatuses, the parameterization is performed for several apparatuses.

Characteristics or particular embodiments of the system, usable alone or in combination, are:

that it comprises a recorder of the geolocation requests.

### BRIEF DESCRIPTION OF THE DRAWINGS

Other characteristics and advantages of the invention will appear upon reading the following description, given only by way of example, with reference to the appended figures, which illustrate:

FIG. 1, a schematic diagram of the main steps of the method according to an embodiment of the invention; and

FIG. 2, a schematic diagram of the system according to an embodiment of the invention.

### DETAILED DESCRIPTION

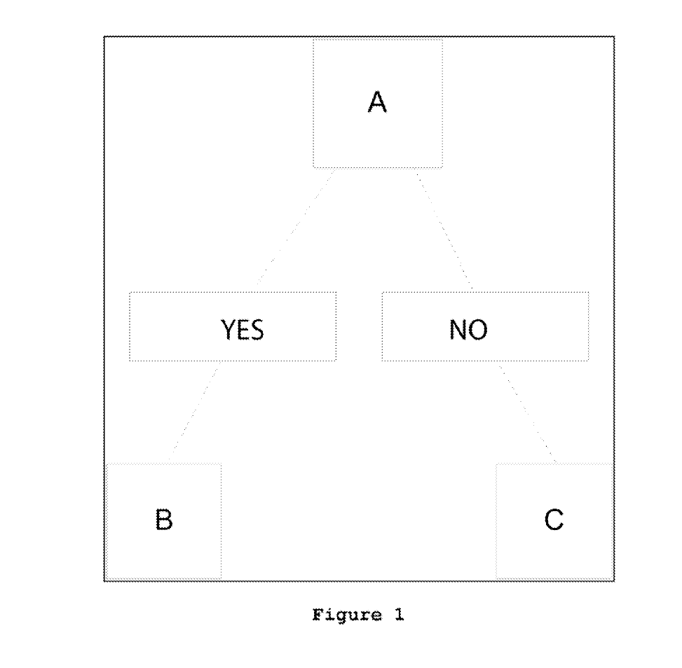

FIG. 1 is a schematic diagram of the main steps of a method for managing the geolocation data.

A first step, labeled A, is a parameterization step of a filter which consists in defining at least one spatio-temporal criterion. This criterion defines the conditions of access by a receiver to geolocation data of a user of an apparatus comprising a geolocation device. If the criterion provides access to data (condition represented by “YES” in FIG. 1), the method comprises a step B which corresponds to the activation by the filter of the transmission by the apparatus of the user of the geolocation data from the apparatus to the receiver. If the criterion does not provide access to data (condition represented by “NO” in FIG. 1), the method comprises a step C which corresponds to the deactivation by the filter of the transmission by the apparatus of the user of the geolocation data from the apparatus to the receiver.

The apparatus is, for example, a smart mobile phone, a tablet, a computer, a gaming console, a television set and any other device integrating a geolocation device.

The filter comprises a database. This database is stored on the apparatus or decentralized, for example on a server or shared through several servers the addresses of which are known by each of them. This database may be complementary according to the used location applications. This database comprises a plurality of receivers. The receivers are private or professional third parties, such as friends, family, advertisers or even operators of a center of interests to which the user has subscribed.

To each one of these receivers, is associated within the database a spatio-temporal criterion. When a receiver wishes to retrieve the geolocation data of a user, the request of the receiver transits through the filter which, depending on the spatio-temporal criterion associated to the receiver, activates, or not, the transmission of the geolocation data from the user to the receiver.

The user has the possibility to parameterize by himself the possible receivers of his geolocation data and the spatio-temporal criteria associated to these receivers. This parameterization is done by means of a user interface. This user interface is a remote control which allows the user to access to the permissions given to receivers and to modify them in real time. This interface may be in the form of an application on smartphones or an application accessible through an Internet browser, on a fixed station for example. The interface allows displaying the permissions given to all services that use the geolocation to which the user has subscribed, and being able to modify them one by one, or in whole.

The spatio-temporal criteria which govern the access by receivers to the geolocation data of the apparatus of a user comprise:

time ranges; and/or

geographical areas.

Regarding the time ranges, it might be a duration during which the user authorizes or not the access to his geolocation data by a receiver. It may also be a period of the day, the month, the year during which the user authorizes or not the access to his geolocation data by a receiver.

Regarding the geographical areas, it might be a country, a state, a town, a postal code, a neighborhood, a named area, a street in which the user authorizes or not the access to his geolocation data by a receiver.

In one alternative, the user can parameterize the precision with which he agrees to be located and hence with which the filter, when he activates it, transmits the geolocation data to a receiver. This precision may, for example, be parameterized as being maximum, reduced to a postal code, a state, a region or a country. Thus, the restitution to the receiver of the geographical position of the user is noisy depending on the geographical precision defined by the user of the apparatus.

If a user has several apparatuses including a geolocation device being able to transmit the geolocation data to a receiver, the parameterization of the filter is synchronized between all the apparatuses of the user. Thus, the user can globally manage the data transmission authorization for all the apparatuses in his possession. The user has an account with an identifier system allowing him to access to his authorization data for all third parties to which he would have agreed to give permissions, and for all the apparatuses including a geolocation device allowing him to be located. Thus, whereas it appears that users often have at their disposal several portable terminals such as a mobile phone, a tablet, a laptop, etc., the user centralizes his management of the geolocation. That allows moving from a perspective of managing the geolocation of an apparatus the position of which is assumed to correspond to the position of the user/owner, to a perspective of the user as such, whatever the number and the quality of the apparatuses that he uses.

In one alternative, when the user adds a new receiver which he wishes to control the possibility of accessing its geolocation data, the method comprises a validation step of the receiver. Thus, in the case of a user using a smart mobile phone having installed a new application that uses geolocation data of the phone, the user parameterizes, via the user interface, the spatio-temporal criteria corresponding to the new application, and a validation step of the receiver is performed by the method.

This validation may be performed according to different modes:

either on a case by case basis depending on each request;

or in a semi-global or global manner, corresponding to a validation for a group or a sub-group the user of which masters its perimeter.

When the receiver that desires to access to the geolocation data of an apparatus of a user comprises a specific application, the filter interfaces with the application to give it or not access to the geolocation data. The filter intercalates with the data requester, which may be an application, and the place where data are stored, wherever these data are located. It is the filter that determines the step of activation or deactivation of the transmission of geolocation data to the application of the receiver. The filter is similar to a switch. If a receiver attempts to retrieve data in spite of the fact that the spatio-temporal criterion defines a deactivation of the transmission, the filter may block the download of said data by a receiver.

In another alternative, if an application attempts to retrieve the geolocation data, in spite of the deactivation by the filter of the transmission of said data, the filter generates an alarm which informs the user that a third party attempts to retrieve his geolocation data. This alarm may, for example, take the form of an audible or visual alarm.

More generally, the filter may record any geolocation request, whether it has been agreed, rejected or, possibly, whether it has attempted to circumvent the filter. That allows the user, by consulting this history, to validate his rules for managing the geolocation and, in the case of a circumvention attempt, to possibly implement legal procedures of personal data protection.

Note that the possibility to be informed of a circumvention of the filter or to prevent it is an implementation option. Indeed, for implementing this, it is necessary to have access to the lower layers of the operating system of the apparatuses in order to be able to intervene at the management driver of the geolocation component. Also, depending on the policy of opening of the owner of the operating system, this access may prove to be difficult, or even impossible.

The implementation of the method is done, for example, by a computer program product comprising program code instructions for the execution of the method precedingly described when this program is executed on a computer. This computer program is, for example, loaded and executed on the system described below.

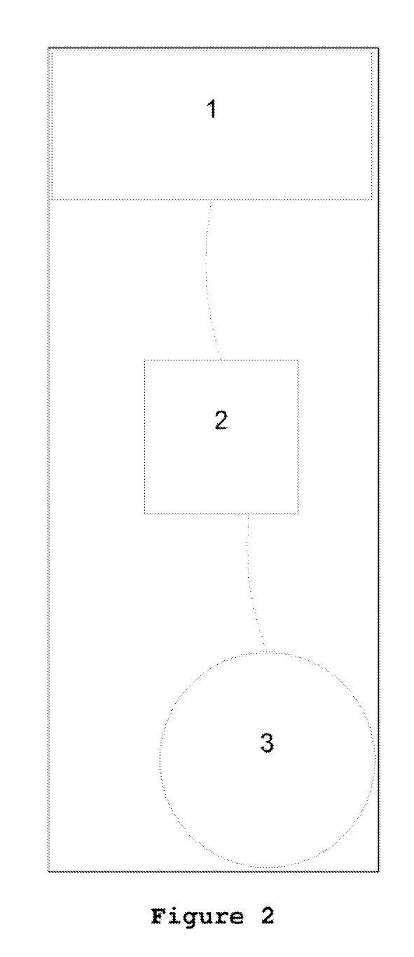

FIG. 2 schematically illustrates such a system for managing the geolocation parameters. The apparatus 1 comprises a geolocation device (not represented in figure) being able to transmit geolocation data to a receiver 3. The apparatus 1 may be a smart mobile phone, a tablet, a computer, a gaming console, a television and any other device integrating a geolocation device.

The receiver 3 is a computer belonging for example to a private or professional third party, a friend, of the family, an advertiser or event an operator of a center of interests to which the user has subscribed. The receiver 3 may comprise an application. The system comprises a filter 2 parameterizable and adapted to define a spatio-temporal criterion of geolocation data accessibility of the apparatus 1 by the receiver 3. This filter 2 activates or deactivates the transmission of the data depending on the spatio-temporal criterion. The filter 2 is intercalates between the apparatus 1 and the receiver 3.

The filter 2 comprises a database (not represented in the figure). This database stores the information related to the receiver, or to a plurality of receivers. Each receiver is associated, in the database, to a spatio-temporal criterion parameterizable by the user of the apparatus 1.

The spatio-temporal criteria which govern the access by receivers 3 to the geolocation data of the apparatus 1 of the user comprise:

time ranges; and/or

geographical areas.

Regarding the time ranges, it might be a duration during which the user authorizes or not access to his geolocation data by a receiver. It might also be a period of the day, the month, the year during which the user authorizes or not the access to his geolocation data by a receiver.

Regarding the geographical areas, it may be a country, a state, a town, a postal code, a neighborhood, a named area, a street in which the user authorizes or not the access to his geolocation data by a receiver.

If a receiver 3 wishes to access the geolocation data of an apparatus 1, its request will travel through the filter 2. The filter 2 will activate or not the transmission of data depending on the spatio-temporal criterion that the user of the apparatus 1 has associated to the receiver 3 (or application of the receiver).

When a user has a plurality of apparatuses including a geolocation device being able to transmit geolocation data to a receiver 1, the database of the filter 2 is synchronized between all the apparatuses of a same user. The user can thus globally manage all the permissions granted to the receivers of his apparatuses.

In one alternative, an SOS button is provided to be able to alert remote assistance providers to which the user would be a subscriber, in the case of a problem and hence bypass the filtering.

When the user operates the SOS button, he implicitly considers that he desires that his position be immediately communicated whatever the permissions, given or not, by the other adjustments of the filter.

The invention has been illustrated and described in detail in the drawings and the preceding description. This should be considered as illustrative and given by way of example and not as limiting the invention to that description alone. Numerous alternative embodiments are possible.

In the claims, the word “comprising” does not exclude other elements and the indefinite article “a/an” does not exclude a plurality.

1.-11. (canceled)

12. A method for managing the location of a user of at least one apparatus that includes a geolocation device being able to transmit geolocation data to a plurality of receivers, comprising:
parameterization of a filter to define at least one spatio-temporal criterion of geolocation data accessibility by at least one of the receivers, the parameterization being done by a user interface allowing the user to parameterize by himself a database associating the receivers and the associated spatio-temporal criteria;
activation or deactivation, by the filter of the transmission of the geolocation data to each receiver depending on the at least one spatio-temporal criterion associated thereto;
wherein the user having a plurality of apparatuses, the parameterization is performed for several apparatuses.

13. The method according to claim 12, wherein the spatio-temporal criterion comprise time ranges and/or geographical areas.

14. The method according to claim 12, wherein when the filter activates the transmission of the geolocation data, which is provided with a precision defined by the user.

15. The method according to claim 12, wherein the parameterization of the filter is synchronized between all the apparatuses.

16. The method according to claim 12, wherein when the filter is parameterized for a new receiver, a validation step of the receiver is performed.

17. The method according to claim 12, wherein the receiver comprises a specific application and the filter interfaces with the application to provide, or not, the geolocation data.

18. The method according to claim 17, wherein the filter generates an alarm when an application attempts to retrieve geolocation data in spite of the deactivation.

19. The method according to claim 12, wherein the filter records every location request to provide the user with a history of location requests.

20. A computer program product comprising program code instructions for the execution of the steps of the method according to claim 12 when the program is executed on a computer.

21. A system for managing the location of a user of an apparatus that includes a geolocation device able to transmit geolocation data to a plurality of receivers, the system comprising a parameterizable filter adapted to define at least one spatio-temporal criterion of geolocation data accessibility for at least one of the receivers and to activate, or deactivate, the transmission of geolocation data to the receiver depending on the spatio-temporal criterion, and a user interface for parameterizing the filter allowing the user to parameterize by himself a database associating the receivers and the spatio-temporal criteria, wherein, the user having a plurality of apparatuses, the parameterization is performed for several apparatuses.

22. The system according to claim 21, wherein it comprises a recorder of the geolocation requests.
